(19) United States
(12) Patent Application Publication
(10) Pub. No.: US 2024/0191009 A1
(43) Pub. Date: Jun. 13, 2024

(54) POLYFUNCTIONALIZED HIGH-CIS 1,4-POLYBUTADIENE AND METHOD FOR MANUFACTURING THE SAME

(71) Applicant: KOREA KUMHO PETROCHEMICAL CO., LTD., Seoul (KR)

(72) Inventors: Han Baek LEE, Seoul (KR); Hoo-Chae KIM, Seoul (KR); Jae Yun KIM, Seoul (KR); Seung Hyun DO, Seoul (KR); Beom Su JANG, Seoul (KR)

(73) Assignee: KOREA KUMHO PETROCHEMICAL CO., LTD., Seoul (KR)

(21) Appl. No.: 18/517,575

(22) Filed: Nov. 22, 2023

(30) Foreign Application Priority Data
Nov. 24, 2022 (KR) 10-2022-0159331

(51) Int. Cl. C08F 136/06; C08C 19/20; C08C 19/22; C08C 19/25; C08F 4/54; C08L 9/06; C08L 91/00

(52) U.S. Cl. CPC C08F 136/06; C08C 19/20; C08C 19/22; C08C 19/25; C08F 4/545; C08L 9/06; C08L 91/00; C08L 2205/025; C08L 2205/035

(57) ABSTRACT

Provided is a rubber mixture, which includes a unit structure derived from a first conjugated diene-based monomer and is functionalized with at least one of the compounds represented by Formulas 1 to 6; and a second low molecular weight rubber polymer, which includes a unit structure derived from a second conjugated diene-based monomer and is functionalized with at least one of the compounds represented by Formulas 1 to 6.

### CROSS-REFERENCE TO RELATED APPLICATION

This application claims priority to and the benefit of Korean Patent Application No. 2022-0159331, filed on Nov. 24, 2022, the disclosure of which is incorporated herein by reference in its entirety.

### BACKGROUND

### 1. Field of the Invention

The present invention relates to polyfunctionalized high-cis rubber.

### 2. Discussion of Related Art

As the demand for rubber compositions increases in various manufacturing fields, such as tires, shoe soles, or gold balls, the value of a conjugated diene-based polymer, which is synthetic rubber, as a substitute for natural rubber, which is in short supply, is increasing.

Generally, the structure of a conjugated diene-based polymer greatly affects its physical properties. Generally, the greater the degree of branching, the higher the dissolution rate and viscosity of the polymer, resulting in improved processability of the polymer. However, as the degree of branching of the polymer increases, the molecular weight distribution tends to broaden, so the mechanical properties that affect the wear resistance, crack resistance, or rebound properties of the rubber composition are rather degraded.

A high-cis conjugated diene-based polymer having a high cis content, e.g., 90 wt % or more has a linear structure. A product manufactured from a high-cis conjugated diene-based polymer has excellent physical properties, but it has problems of poor processability, poor compatibility with a reinforcing agent, and poor storage because of high viscosity and high cold flow.

In other words, if other conditions are the same, the linearity or branching degree of the conjugated diene-based polymer greatly depends on the content of cis bonds contained in the polymer. The higher the content of cis bonds in the conjugated diene-based polymer, the higher the linearity, and thus the polymer has excellent mechanical properties. As a result, the wear resistance, crack resistance, and rebound properties of the rubber composition may be improved.

Accordingly, various methods of preparing a conjugated diene-based polymer have been researched and developed to improve mechanical properties and impart appropriate processability by increasing the content of cis bonds in the conjugated diene-based polymer. For example, a method of producing a conjugated diene-based polymer having high linearity using a polymerization system including a lanthanide-containing compound, particularly, a neodymium-based compound, or a polymerization system including a nickel-based compound was proposed.

In addition, while a method of improving processability by mixing a low molecular weight liquid polymer and a high molecular weight polymer has been proposed, it had a problem of reducing the physical properties of a final product because it is difficult to uniformly mix a liquid polymer, a high molecular weight polymer, and a reinforcing material in the preparation of a rubber compound.

The present specification was created after finding that processability and mechanical properties, which are in a trade-off relationship, can be improved at the same time by separately preparing low molecular weight and high molecular weight conjugated diene-based polymers with a high cis content, modifying these two types of polymers with functional compounds, and mixing them.

### SUMMARY OF THE INVENTION

The present invention is directed to providing polyfunctionalized high-cis rubber, which improves the problem of decreased processability and dispersity of a reinforcing material in the use of the polyfunctionalized high-cis rubber.

According to an aspect of the present invention, there is provided a rubber mixture, which includes a first high molecular weight rubber polymer, which includes a unit structure derived from a first conjugated diene-based monomer and is functionalized with at least one of the compounds represented by Formulas 1 to 6 below; and a second low molecular weight rubber polymer, which includes a unit structure derived from a second conjugated diene-based monomer and is functionalized with at least one of the compounds represented by Formulas 1 to 6 below:

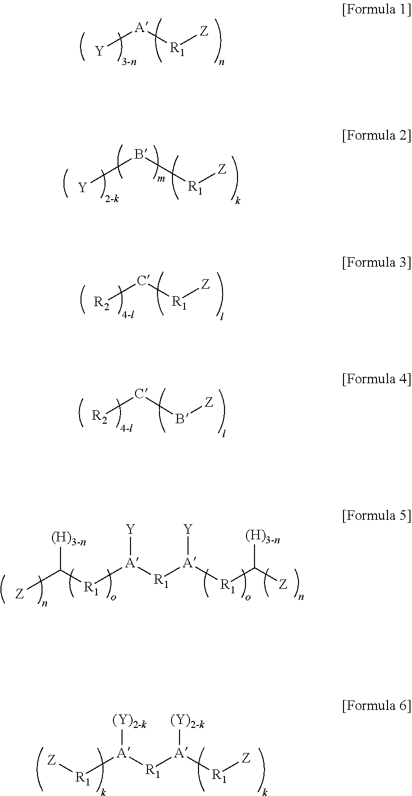

In the above formulas, A′ is nitrogen or phosphorus, B′ is oxygen or sulfur, C′ is silicon or tin, Y is hydrogen, —R₂, —Si(R₂)₃, or —R₁Si(OR₂)₃, Z is a functional group represented by Formula Z below, n is an integer of 1 to 3, m is an integer of 1 or more, k is 1 or 2, l is an integer of 1 to 4, and o is 0 or 1,

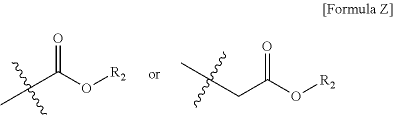

R₁ is each independently a linear or branched, substituted or unsubstituted C1-C10 alkylene group, and R₂ is each independently a linear or branched, substituted or unsubstituted C1-C20 alkyl group, substituted or unsubstituted C3-C20 cycloalkyl group, or substituted or unsubstituted C6-C20 aryl group.

In one embodiment, each of the first conjugated diene-based monomer and the second conjugated diene-based monomer may be at least one selected from the group consisting of 1,3-butadiene, isoprene, 2,3-dimethyl-1,3-butadiene, 2,3-dimethylbutadiene, 2-phenyl-1,3-butadiene, 2-chloro-1,3-butadiene, 1,3-pentadiene, 2-methyl-1,3-pentadiene, 3-methyl-1,3-pentadiene, 4-methyl-1,3-pentadiene, 1,3-hexadiene, 2-ethyl-1,3-butadiene, 2,4-hexadiene, and 1,3-cyclohexadiene.

In one embodiment, the first rubber polymer may have a weight average molecular weight of 100,000 to 1,500,000 g/mol.

In one embodiment, the second rubber polymer may have a weight average molecular weight of 5,000 to 100,000 g/mol.

In one embodiment, the weight ratio of the first and second rubber polymers may be 100:5 to 45.

In one embodiment, the first and second rubber polymers may be functionalized with the same compound.

In one embodiment, the molecular weight distribution may be 3.5 or more.

In one embodiment, the linearity may be 1.5 to 2.5.

In one embodiment, the content of cis bonds may be 90% or more.

According to another aspect of the present invention, there is provided a method of preparing a rubber mixture, which includes: (a1) preparing a first high molecular weight rubber polymer by allowing a solution containing a first conjugated diene-based monomer, a first solvent, and a first catalyst to react, and further adding and allowing at least one of the compounds represented by Formulas 1 to 6 to react; (a2) preparing a second low molecular weight rubber polymer by allowing a solution containing a second conjugated diene-based monomer, a second solvent, and a second catalyst to react, and further adding and allowing at least one of the compounds represented by Formulas 1 to 6 to react; and (b) mixing the first high molecular weight rubber polymer and the second low molecular weight rubber polymer.

In one embodiment, in (a1), the weight ratio of the first conjugated diene-based monomer and the first solvent may be 1:1 to 5.5, and in (a2), the weight ratio of the second conjugated diene-based monomer and the second solvent may be 1:5.5 to 10.

According to still another aspect of the present invention, there is provided a rubber composition, which includes: the above-described rubber mixture; at least one third rubber selected from the group consisting of natural rubber, polybutadiene rubber, polyisoprene rubber, butyl rubber, an ethylene-propylene-diene terpolymer, emulsion polymerized styrene-butadiene rubber, and solution polymerized styrene-butadiene rubber; and a reinforcing material.

In one embodiment, the reinforcing material may include at least one selected from the group consisting of silica, carbon black, carbon nanotubes, calcium carbonate, clay, aluminum hydroxide, lignin, silicate, talc, syndiotactic-1,2-polybutadiene, titanium oxide, mica, vermiculite, and hydrotalcite.

In one embodiment, the rubber composition may further include at least one selected from the group consisting of an aromatic petroleum resin, an aliphatic olefin polymer, and a farnesene-based polymer.

### DETAILED DESCRIPTION OF EXEMPLARY EMBODIMENTS

Exemplary embodiments of this specification will be described below. However, the description of this specification may be embodied in various forms, and thus is not limited to examples to be described below.

Throughout the specification, when a part is “connected” to another part, it means that the one part is “directly connected,” or “indirectly connected” with a third member therebetween. In addition, when a certain part “includes” a certain component, it means that, unless particularly stated otherwise, another component may be further included, rather than excluding the other component.

When ranges of numerical values are set forth herein, unless the specific range is stated otherwise, the values have precision of significant figures provided in accordance with the standard rules in chemistry for significant figures. For example, the number 10 includes the range of 5.0 to 14.9, and the number 10.0 includes the range of 9.50 to 10.49.

In this specification, “including a monomer-derived unit structure” means that a (co)polymer that is obtained using the monomer includes a repeating structure derived from the monomer. An example of a method of measuring the content (wt %) of the unit structure is nuclear magnetic resonance (NMR) such as ¹H-NMR.

In this specification, “conjugated diene” refers to a hydrocarbon-based compound having a structure in which two carbon-carbon double bonds are linked by a carbon-carbon single bond.

In this specification, “functionalization” is also called modification, and means that a unit structure derived from a compound having a specific function is included in a (co)polymer.

In this specification, “linear” refers to a structure where the carbons constituting a compound are sequentially arranged, and “branched” refers to a structure where at least one carbon constituting a compound is linked to three or more carbons.

### Rubber Mixture

A rubber mixture according to one aspect includes a unit structure derived from a first conjugated diene-based monomer and is functionalized with at least one of the compounds represented by Formulas 1 to 6 below; and a second low molecular weight rubber polymer, which includes a unit structure derived from a second conjugated diene-based monomer and is functionalized with at least one of the compounds represented by Formulas 1 to 6 below:

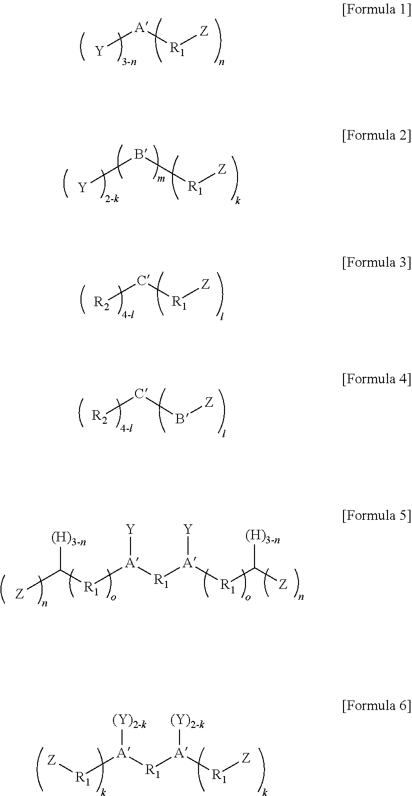

In the above formulas, A′ is nitrogen or phosphorus, B′ is oxygen or sulfur, C′ is silicon or tin, Y is hydrogen, —R₂, —Si(R₂)₃, or —R₁Si(OR₂)₃, Z is a functional group represented by Formula Z below, n is an integer of 1 to 3, m is an integer of 1 or more, k is 1 or 2, l is an integer of 1 to 4, and o is 0 or 1,

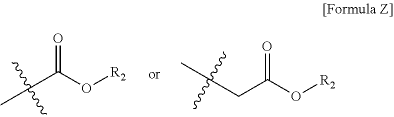

R₁ is each independently a linear or branched, substituted or unsubstituted C1-C10 alkylene group, and R₂ is each independently a linear or branched, substituted or unsubstituted C1-C20 alkyl group, substituted or unsubstituted C3-C20 cycloalkyl group, or substituted or unsubstituted C6-C20 aryl group.

Here, when o in the compound of Formula 5 is 0, A′ may be directly linked to —C(Z)n(H)₃-n without R₁.

R₁ may be, for example, a linear alkylene group such as a methylene group, an ethylene group, a 1,3-propylene group, a 1,4-butylene group, a 1,5-pentamethylene group, a 1,6-hexamethylene group, a 1,7-heptamethylene group, a 1,8-octamethylene group, a 1,9-nonamethylene group, or a 1,10-decamethylene group; a branched alkylene group such as a 1,2-propylene group, a 1,2-butylene group, a 1,3-butylene group, a 1,2-pentylene group, a 1,3-pentylene group, a 1,4-pentylene group, a 1,2-hexylene group, a 1,3-hexylene group, a 1,4-hexylene group, a 1,5-hexylene group, a 1,2-heptylene group, a 1,3-heptylene group, a 1,4-heptylene group, a 1,5-heptylene group, a 1,6-heptylene group, a 1,2-octylene group, a 1,3-octylene group, a 1,4-octylene group, a 1,5-octylene group, a 1,6-octylene group, a 1,7-octylene group, a 1,2-nonylene group, a 1,3-nonylene group, a 1,4-nonylene group, a 1,5-nonylene group, a 1,6-nonylene group, a 1,7-nonylene group, a 1,8-nonylene group, a 1,2-decylene group, a 1,3-decylene group, a 1,4-decylene group, a 1,5-decylene group, a 1,6-decylene group, a 1,7-decylene group, a 1,8-decylene group, a 1,9-decylene group, a 2-methylbutane-1,4-diyl group, a 2-ethylbutane-1,4-diyl group, a 2-methylpentane-1,5-diyl group, or a 3-methylpentane-1,5-diyl group; or a linear or branched alkylene group in which at least one carbon is substituted with a hetero atom such as nitrogen, oxygen, sulfur, or a halogen, but the present invention is not limited thereto.

R₂ may be, for example, a linear alkyl group such as a methyl group, an ethyl group, a 1-propyl group, a 1-butyl group, a 1-pentyl group, a 1-hexyl group, a 1-heptyl group, a 1-octyl group, a 1-nonyl group, a 1-decyl group, a 1-undecyl group, a 1-dodecyl group, a 1-tridecanyl group, a 1-tetradecanyl group, a 1-pentadecanyl group, a 1-hexadecanyl group, a 1-heptadecanyl group, a 1-octanecanyl group, a 1-nonadecanyl group, or a 1-icosanyl group; a branched alkyl group such as a 2-methylpropyl group, a 2-ethylpropyl group, a 2-methylbutyl group, a 2,3-dimethylbutyl group, a 2-ethylbutyl group, a 2-ethyl-3-methylbutyl group, a 2-propylbutyl group, a 2-isopropylbutyl group, a 2-methylpentyl group, a 2,3-dimethylpentyl group, a 2,4-dimethylpentyl group, a 3,4-dimethylpentyl group, a 2-ethyl-3-methylpentyl group, a 2-methyl-3ethylpentyl group, a 3-ethyl-4methylpentyl group, a 2-ethylpentyl group, a 2-propylpentyl group, a 2-isopropylpentyl group, a 2-butylpentyl group, a 2-methylhexyl group, a 2-ethylhexyl group, a 2-propylhexyl group, a 2-butylhexyl group, a 2-methylheptyl group, a 2-ethylheptyl group, a 2-propylheptyl group, a 2-methyloctyl group, a 2-ethyloctyl group, a 2-methylnonyl group, a 3-methylbutyl group, a 3-ethylbutyl group, a 3-propylbutyl group, a 3-methylpentyl group, a 3-ethylpentyl group, a 3-propylpentyl group, a 3-butylpentyl group, a 3-methylhexyl group, a 3-ethylhexyl group, a 3-propylhexyl group, a 3-butylhexyl group, a 3-methylheptyl group, a 3-ethylheptyl group, a 3-propylheptyl group, a 3-methyloctyl group, a 3-ethyloctyl group, a 3-methylnonyl group, a 4-methylpentyl group, a 4-ethylpentyl group, a 4-propylpentyl group, a 4-butylpentyl group, a 4-methylhexyl group, a 4-ethylhexyl group, a 4-propylhexyl group, a 4-butylhexyl group, a 4-methylheptyl group, a 4-ethylheptyl group, a 4-propylheptyl group, a 4-methyloctyl group, a 4-ethyloctyl group, a 4-methylnonyl group, a 5-methylhexyl group, a 5-ethylhexyl group, a 5-propylhexyl group, a 5-butylhexyl group, a 5-methylheptyl group, a 5-ethylheptyl group, a 5-propylheptyl group, a 5-methyloctyl group, a 5-ethyloctyl group, a 5-methylnonyl group, a 6-methylheptyl group, a 6-ethylheptyl group, a 6-propylheptyl group, a 6-methyloctyl group, a 6-ethyloctyl group, a 6-methylnonyl group, a 7-methyloctyl group, a 7-ethyloctyl group, a 7-methylnonyl group, or a 8-methylnonyl group; a cycloalkyl group such as a cyclopropyl group, a cyclobutyl group, a cyclopentyl group, a cyclohexyl group, a cycloheptyl group, a cyclooctyl group, a cyclononyl group, or a cyclodecyl group; an aryl group such as a benzyl group, a tollyl group, a naphthyl group, an azulyl group, an anthracyl group, a phenallyl group, or a piryl group, or a linear, branched, cycloalkyl, or aryl group in which at least one carbon is substituted with a hetero atom such as nitrogen, oxygen, sulfur, or a halogen, but the present invention is not limited thereto.

Each of the first and second rubber polymers may be independently a conjugated diene-based polymer functionalized with at least one of the compounds represented by Formulas 1 to 6. The compounds represented by Formulas 1 to 6 may have two or more ester groups with high reactivity introduced to an active site of the polymer. Such a functional compound may achieve a high functionalization rate (modification rate) of the polymer, and thus can effectively induce molecular adjustment. In addition, the functional compound may be introduced to a polymer chain to uniformly increase the dispersity with a reinforcing material. As a result, in the preparation of the rubber composition including the first and second rubber polymers, processability, viscoelasticity, and mechanical properties may be significantly improved.

As an example, when Y in the compounds of Formulas 1, 2, 5, and 6 is a functional group having Si, a relatively high modification rate may be shown by protecting A′ or B′ in a form of —NSi—, —PSi—, —OSi—, or —SSi—. As a result, the properties of the molecule may be more effectively adjusted.

As another example, when B′in the compound of Formula 2 or 4 is S, a high modification rate may be shown by promoting the modification of the rubber by a —S— or —SSn— structure. A compound in which B′is O or a compound in which C′ is Si may also promote the modification of the rubber polymer to exhibit a similar effect.

In one example, functional compounds that are introduced to the first and second rubber polymers may each satisfy at least one of the conditions (i) to (vi):
(i) the compound represented by Formula 1 has a symmetrical structure centered on A′;
(ii) the compound represented by Formula 2 has a symmetrical structure centered on B′;
(iii) the compound represented by Formula 3 has a symmetrical structure centered on C′;
(iv) the compound represented by Formula 4 has a symmetrical structure centered on C′;
(v) the compound represented by Formula 5 has a symmetrical structure centered on R₁ located between two A's;
(vi) the compound represented by Formula 6 has a symmetrical structure centered on R₁ located between two A's.

This symmetrical structure may enhance the functionalization rate, which refers to the rate at which a functional compound is incorporated into either the first or second rubber polymer. As a result, the physical properties of the functionalized rubber polymer may be effectively improved.

Each of the first conjugated diene-based monomer and the second conjugated diene-based monomer may be at least one selected from the group consisting of 1,3-butadiene, isoprene, 2,3-dimethyl-1,3-butadiene, 2,3-dimethylbutadiene, 2-phenyl-1,3-butadiene, 2-chloro-1,3-butadiene, 1,3-pentadiene, 2-methyl-1,3-pentadiene, 3-methyl-1,3-pentadiene, 4-methyl-1,3-pentadiene, 1,3-hexadiene, 2-ethyl-1,3-butadiene, 2,4-hexadiene, and 1,3-cyclohexadiene.

When the first conjugated diene-based monomer and the second conjugated diene-based monomer are the same, it may easily increase the compatibility between the first and second rubber polymers.

The weight average molecular weight of the first rubber polymer may be 100,000 to 1,500,000 g/mol. For example, the weight average molecular weight of the first rubber polymer may be 100,000 g/mol, 125,000 g/mol, 150,000 g/mol, 175,000 g/mol, 200,000 g/mol, 225,000 g/mol, 250,000 g/mol, 275,000 g/mol, 300,000 g/mol, 325,000 g/mol, 350,000 g/mol, 375,000 g/mol, 400,000 g/mol, 425,000 g/mol, 450,000 g/mol, 475,000 g/mol, 500,000 g/mol, 525,000 g/mol, 550,000 g/mol, 575,000 g/mol, 600,000 g/mol, 625,000 g/mol, 650,000 g/mol, 675,000 g/mol, 700,000 g/mol, 725,000 g/mol, 750,000 g/mol, 775,000 g/mol, 800,000 g/mol, 825,000 g/mol, 850,000 g/mol, 875,000 g/mol, 900,000 g/mol, 925,000 g/mol, 950,000 g/mol, 975,000 g/mol, 1,000,000 g/mol, 1,100,000 g/mol, 1,200,000 g/mol, 1,300,000 g/mol, 1,400,000 g/mol, or 1,500,000 g/mol, or in a range between two of these values. When the weight average molecular weight of the first rubber polymer is outside the above range, the physical properties of the final product may be insufficient, or it may be impossible to prepare the polymer.

The weight average molecular weight of the second rubber polymer may be 5,000 to 100,000 g/mol. For example, the weight average molecular weight of the second rubber polymer may be 5,000 g/mol, 7,500 g/mol, 10,000 g/mol, 12,500 g/mol, 15,000 g/mol, 17,500 g/mol, 20,000 g/mol, 22,500 g/mol, 25,000 g/mol, 27,500 g/mol, 30,000 g/mol, 32,500 g/mol, 35,000 g/mol, 37,500 g/mol, 40,000 g/mol, 42,500 g/mol, 45,000 g/mol, 47,500 g/mol, 50,000 g/mol, 52,500 g/mol, 55,000 g/mol, 57,500 g/mol, 60,000 g/mol, 62,500 g/mol, 65,000 g/mol, 67,500 g/mol, 70,000 g/mol, 72,500 g/mol, 75,000 g/mol, 77,500 g/mol, 80,000 g/mol, 82,500 g/mol, 85,000 g/mol, 87,500 g/mol, 90,000 g/mol, 92,500 g/mol, 95,000 g/mol, 97,500 g/mol, or 100,000 g/mol, or in a range between two of these values. When the weight average molecular weight of the second rubber polymer is outside the above range, the polymer may not be a liquid at room temperature, or the compatibility with the first rubber polymer may be reduced.

The first rubber polymer is a high molecular weight polymer, which may be a solid at 25° C. The first rubber polymer may have excellent mechanical properties due to high linearity. However, when the first rubber polymer is used alone, productivity is insufficient due to high viscosity, and storage properties may be poor due to high cold flow. In addition, it was expected that a product with excellent wear resistance could be manufactured using this first high molecular weight rubber polymer. However, when the first rubber polymer is used alone, due to poor processability and difficult dispersion of the reinforcing material, the mechanical properties of the prepared rubber compound may be insufficient.

The second rubber polymer is a low molecular weight polymer, which may be a liquid at 25° C. The second rubber polymer has excellent compatibility with the first rubber polymer and can improve the above-described disadvantages of the first rubber polymer. The mixture of the first and second rubber polymers may allow the reinforcing material to be easily dispersed. As a result, when manufacturing the rubber compound, processibility may increase, and mechanical properties including viscoelasticity and wear resistance may be improved. In addition, due to a higher proportion of functional groups, the second rubber polymer may exhibit greater affinity to the reinforcing material compared to the first rubber polymer of the same weight.

The second rubber polymer may perform a role similar to a kind of processing aid in relationship with the first rubber polymer. Therefore, when preparing a compound including a rubber mixture, compared to a conventional process of preparing a rubber compound, even a relatively smaller amount of processing aid may be used to exhibit sufficient processability. In addition, compared to rubber elongated using a process oil alone as a processing aid, the dispersibility of the reinforcing material may become excellent, and the physical properties of the rubber compound may also be improved.

The weight ratio of the first and second rubber polymers may be 100:5 to 45. For example, the second rubber polymer may be mixed at 5 parts by weight, 6 parts by weight, 7 parts by weight, 8 parts by weight, 9 parts by weight, 10 parts by weight, 11 parts by weight, 12 parts by weight, 13 parts by weight, 14 parts by weight, 15 parts by weight, 16 parts by weight, 17 parts by weight, 18 parts by weight, 19 parts by weight, 20 parts by weight, 21 parts by weight, 22 parts by weight, 23 parts by weight, 24 parts by weight, 25 parts by weight, 26 parts by weight, 27 parts by weight, 28 parts by weight, 29 parts by weight, 30 parts by weight, 31 parts by weight, 32 parts by weight, 33 parts by weight, 34 parts by weight, 35 parts by weight, 36 parts by weight, 37 parts by weight, 38 parts by weight, 39 parts by weight, 40 parts by weight, 41 parts by weight, 42 parts by weight, 43 parts by weight, 44 parts by weight, or 45 parts by weight, or in a range between two of these values, based on 100 parts by weight of the first rubber polymer. When the content of the second rubber polymer is outside the above range, the effect caused by mixing the second rubber polymer may not be exhibited, or the physical properties of the rubber compound may be degraded.

In one example, the first and second rubber polymers may be functionalized with the same compound among the above-described compounds represented by Formulas 1 to 6. When the first and second rubber polymers have the same functional group, the affinity between the first and second rubber polymers may further increase.

The first rubber polymer or second rubber polymer may have a molecular weight distribution (MWD) of 1.50 to 3.0, for example, 1.50, 1.55, 1.60, 1.65, 1.70, 1.75, 1.80, 1.85, 1.90, 1.95, 20, 2.05, 2.10, 2.15, 2.20, 2.25, 2.30, 2.35, 2.40, 2.45, 2.50, 2.55, 2.60, 2.65, 2.70, 2.75, 2.80, 2.85, 2.90, 2.95, or 3.0, or in a range between two of these values. When the molecular weight distribution satisfies the above range, a final product may exhibit excellent mechanical properties.

The rubber mixture may have a molecular weight distribution of 3.5 or more. For example, the molecular weight distribution of the rubber mixture may be 3.5, 3.6, 3.7, 3.8, 3.9. 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10 or more, or in a range between two of these values. The molecular weight distribution is a value obtained by dividing a weight average molecular weight (Mw) by a number average molecular weight (Mn). Either the first or second rubber polymer may have a low molecular weight distribution value, but the rubber mixture in which the first high molecular weight rubber polymer and the second low molecular weight rubber polymer are mixed may have a relatively higher molecular weight distribution value. For example, the larger the difference in molecular weight between the first and second rubber polymers, the wider the molecular weight distribution. A rubber mixture whose molecular weight distribution value satisfies the above range because specific first and second rubber polymers are mixed may have an excellent balance between processability and physical properties.

The rubber mixture may have a linearity of 1.5 to 2.5, for example, 1.5, 1.6, 1.7, 1.8, 1.9, 2.0, 2.1, 2.2, 2.3, 2.4, or 2.5, or in a range between two of these values. Generally, a rubber polymer having a high cis content has high linearity, so it has poor processability. The rubber mixture according to the specification may have improved processibility by mixing the first high molecular weight rubber polymer and the second low molecular weight rubber polymer, thereby addressing the above problem.

The linearity of the rubber polymer or rubber mixture may be measured in various ways. In one example, linearity may be obtained as a value (MV/SV*10) measured by measuring a Mooney viscosity (MV) and a solution viscosity (SV) at 25° C. and multiplying their ratio by 10.

The first rubber polymer and the second rubber polymer may be formed by chain bonding functionalized polymer molecules with high linearity and a narrow molecular weight distribution. As a result, these rubber polymers may have excellent mechanical properties due to high linearity and a uniform molecular weight.

In one example, the rubber mixture may have a molecular weight distribution of 3.5 or more by mixing the first and second rubber polymers, which have a narrow molecular weight distribution. As described above, at least one of the first and second rubber polymers may have a narrow molecular weight distribution, but the rubber mixture in which these polymers are mixed may have a high molecular weight distribution value depending on the difference in molecular weight between the polymers. This rubber mixture may improve both physical properties and processability, which are in a trade-off relationship.

The “cis bond” used in the specification may refer to a bond in which structures connected to both ends of the double bond in the main chain of a unit derived from a conjugated diene-based monomer in the first rubber polymer or second rubber polymer are on the same side. For example, in the unit structure of a polybutadiene, a bond where C1 and C4 are located on the same side with the C2-C3 double bond therebetween may be a 1,4-cis bond.

The rubber mixture may have a cis content of 90 wt % or more, 91 wt % or more, 92 wt % or more, 93 wt % or more, 94 wt % or more, 95 wt % or more, or 96 wt % or more. As the cis content of the rubber mixture increases, the heat resistance and viscoelasticity of the final product may be improved.

Generally, in the case of a rubber polymer having a high content of cis bonds, a product manufactured therefrom has excellent mechanical properties but poor productivity and storage stability due to its high viscosity and high cold flow. In addition, since the rubber polymer has poor affinity and compatibility with a reinforcing material and thus the dispersity of the reinforcing material is low, the mechanical properties and dynamic properties of the final product are degraded. However, although the rubber mixture in which the first and second rubber polymers, functionalized with the compounds represented by Formulas 1 to 6, are mixed has a high content of cis bonds, it has excellent processability, and excellent compatibility with the reinforcing material, so both mechanical and dynamic properties of the final product may be improved in a balanced manner.

The first rubber polymer may have a cis content of 90 wt % or more, 91 wt % or more, 92 wt % or more, 93 wt % or more, 94 wt % or more, 95 wt % or more, or 96 wt % or more. As the cis content of the first rubber polymer increases, the rubber mixture may exhibit excellent linearity and elasticity and decreased hysteresis.

The second rubber polymer may have a cis content of 70 wt % or more, 75 wt % or more, 80 wt % or more, 85 wt % or more, 90 wt % or more, or 95 wt % or more. In one example, as long as the cis content of the rubber mixture is satisfied, the second rubber polymer may have a lower cis content, compared to the first rubber polymer.

### Method of Preparing Rubber Mixture

A method of preparing a rubber mixture according to one aspect may include: (a1) preparing a first high molecular weight rubber polymer by allowing a solution containing a first conjugated diene-based monomer, a first solvent, and a first catalyst to react, and further adding and allowing at least one of the compounds represented by Formulas 1 to 6 to react; (a2) preparing a second low molecular weight rubber polymer by allowing a solution containing a second conjugated diene-based monomer, a second solvent, and a second catalyst to react, and further adding and allowing at least one of the compounds represented by

Formulas 1 to 6 to react; and (b) mixing the first high molecular weight rubber polymer and the second low molecular weight rubber polymer.

Here, (a1) and (a2) may be performed in any order.

Each of the functional compounds represented by Formulas 1 to 6 may be added in the middle of the polymerization of conjugated diene-based monomers, that is, in the presence of a catalytic active site with living properties. Therefore, the linearity and molecular structure of the polymer can be controlled, thereby adjusting the chemical and physical reactivity with the reinforcing material.

In one example, the first catalyst and the second catalyst may be the same type. For example, the first catalyst or second catalyst may be a neodymium-based catalyst prepared from a unimolecular neodymium salt compound. The neodymium-based catalyst is a compound prepared by coordinate bonding between a central metal element and a ligand, and the unimolecular neodymium salt compound may be at least one selected from the group consisting of neodymium hexanoate, neodymium heptanoate, neodymium octanoate, neodymium octoate, neodymium naphthenate, neodymium stearate, neodymium versatate, neodymium bis(2-ethylhexyl)phosphate, neodymium bis(1-methylheptyl)phosphate, neodymium(mono-2-ethylhexyl-2-ethylhexyl)phosphonate), and neodymium bis(2-ethylhexyl)phosphite, but the present invention is not limited thereto.

According to one example, the neodymium-based catalyst may be a catalyst that is aged under certain conditions by mixing a neodymium salt compound, a conjugated diene-based monomer, an organic aluminum chloride compound, and one or more organic aluminum compounds in a predetermined molar ratio, for example, 1:5 to 30:1 to 5:10 to 60.

This neodymium-based catalyst may be prepared by aging after mixing the conjugated diene-based monomer at 5 to 30 moles, for example, 5, 6, 7, 8, 9, 10, 11, 12, 13, 14, 15, 16, 17, 18, 19, 20, 21, 22, 23, 24, 25, 26, 27, 28, 29, or 30 moles, or in a range between two of these values, based on 1 mole of the unimolecular neodymium salt compound, but the present invention is not limited thereto.

Here, the neodymium-based catalyst may be preparing by aging after mixing the organic aluminum chloride compound at 1 to 5 moles, for example, 1, 2, 3, 4, or 5 moles or in a range between two of these values, based on 1 mole of the unimolecular neodymium salt compound, but the present invention is not limited thereto.

In addition, the neodymium-based catalyst may be prepared by aging after mixing one or more organic aluminum compounds or organic aluminoxanes at 10 to 60 moles, for example, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 moles, or in a range between two of these values, based on 1 mole of the unimolecular neodymium salt compound, but the present invention is not limited thereto.

A solvent for preparing the catalyst is not particularly limited, and may be a non-polar solvent, an aliphatic hydrocarbon, a cycloaliphatic hydrocarbon, benzene, ethylbenzene, toluene, or xylene, which has no reactivity with the catalyst. For example, the solvent may be at least one selected from the group consisting of pentane, hexane, isopentane, heptane, octane, isooctane, cyclopentane, methylcyclopentane, cyclohexane, methylcyclohexane, and ethylcyclohexane.

The organic aluminum chloride compound may be at least one selected from the group consisting of diethyl aluminum chloride, dimethyl aluminum chloride, dipropyl aluminum chloride, diisobutyl aluminum chloride, dihexyl aluminum chloride, dioctyl aluminum chloride, ethyl aluminum dichloride, methyl aluminum dichloride, propyl aluminum dichloride, isobutyl aluminum dichloride, hexyl aluminum dichloride, octyl aluminum dichloride, ethyl aluminum sesquichloride, methyl aluminum sesquichloride, propyl aluminum sesquichloride, isobutyl aluminum sesquichloride, hexyl aluminum sesquichloride, and octyl aluminum sesquichloride, but the present invention is not limited thereto.

The organic aluminum compound or organic aluminoxane may be at least one selected from the group consisting of trimethylaluminum, triethylaluminum, tripropylaluminum, tributylaluminum, triisobutylaluminum, trihexylaluminum, trioctylaluminum, diisobutylaluminum hydride, dimethylaluminum hydride, diethylaluminum hydride, dipropylaluminum hydride, dibutylaluminum hydride, diisobutylaluminum hydride, dihexylaluminum hydride, dioctylaluminum hydride, methylaluminoxane (MAO), modified methylaluminoxane (MMAO), ethylaluminoxane, propylaluminoxane, isobutylaluminoxane, isobutylaluminoxane, hexylaluminoxane, and octylaluminoxane, but the present invention is not limited thereto.

When a rubber polymer is prepared using such a neodymium-based catalyst, a high-cis rubber polymer with a high cis content may be prepared.

In addition, the molecular weight of the prepared rubber polymer may be controlled by adjusting the composition ratio of the catalyst. For example, a low molecular weight polymer may be prepared by relatively increasing the proportion of the organic aluminum compound or organic aluminoxane, but the present invention is not limited thereto.

In addition, the molecular weight of the polymer may be controlled by adjusting the proportion of the monomer and the solvent. For example, in (a1), the weight ratio of the first conjugated diene-based monomer and the first solvent may be 1:1 to 5.5, and in (a2), the weight ratio of the second conjugated diene-based monomer and the second solvent may be 1:5.5 to 10.

When the amount of solvent compared to the monomer is small, a high molecular weight polymer may be prepared. Accordingly, in (a1), a first high molecular weight rubber polymer may be prepared, and in (a2), a second low molecular weight rubber polymer may be prepared.

Here, each of the first solvent and the second solvent may be at least one selected from the group consisting of pentane, hexane, isopentane, heptane, octane, isooctane, cyclopentane, methylcyclopentane, cycloheptane, methylcyclohexane, ethylcyclohexane, benzene, toluene, ethylbenzene, and xylene.

(b) is to mix the first high molecular weight rubber polymer and the second low molecular weight polymer, which have been polymerized, and here, the weight ratio of the first and second rubber polymers may be 100:5 to 45. This is as described above.

When the same types of monomer, functional compound and catalyst are used in the preparation of the first and second rubber polymers, a uniformly mixed rubber mixture may be easily prepared in (b). A rubber mixture prepared by premixing the-first high molecular weight rubber polymer and the second low molecular weight rubber polymer may be applied in the same manner as a common rubber polymer in compounding.

### Rubber Composition

A rubber composition according to one aspect may include the above-described rubber mixture; at least one third rubber selected from the group consisting of natural rubber, polybutadiene rubber, polyisoprene rubber, butyl rubber, an ethylene-propylene-diene terpolymer, emulsion polymerized styrene-butadiene rubber, and solution polymerized styrene-butadiene rubber; and a reinforcing material.

The above-described rubber mixture has improved dispersibility with the reinforcing material by a substitution or coupling reaction of a functional compound at the end of the chain, and may have excellent processability in the preparation of the rubber composition. In addition, the prepared rubber composition may have excellent viscoelasticity and mechanical properties.

The rubber mixture may be compounded in the preparation of a rubber composition while the first and second rubber polymers are premixed, before compounding.

As the third rubber, depending on the characteristics of the final product, at least one selected from the group consisting of natural rubber, polybutadiene rubber, polyisoprene rubber, butyl rubber, an ethylene-propylene-diene terpolymer, emulsion polymerized styrene-butadiene rubber, and solution polymerized styrene-butadiene rubber may be used. In addition, the third rubber may have at least one end modified by a functionalizing agent or coupling agent.

The weight ratio of the rubber mixture and the third rubber may be 10 to 70:30 to 90, for example, 10:90, 15:85, 20:80, 25:75, 30:70, 35:65, 40:60, 45:55, 50:50, 55:45, 60:40, 65:35, or 70:30, but the present invention is not limited thereto.

The reinforcing material may be at least one selected from the group consisting of silica, carbon black, carbon nanotubes, calcium carbonate, clay, aluminum hydroxide, lignin, silicate, talc, syndiotactic-1,2-polybutadiene, titanium oxide, mica, vermiculite, and hydrotalcite, but the present invention is not limited thereto.

Since the above-described first rubber polymer and second rubber polymer are functionalized by any of the compounds represented by Formulas 1 to 6, the dispersibility of the reinforcing material in the rubber composition may be excellent.

Based on a total of 100 parts by weight of the rubber mixture and the third rubber, the content of the reinforcing material may be 10 to 200 parts by weight, for example, 10 parts by weight, 20 parts by weight, 30 parts by weight, 40 parts by weight, 50 parts by weight, 60 parts by weight, 70 parts by weight, 80 parts by weight, 90 parts by weight, 100 parts by weight, 110 parts by weight, 120 parts by weight, 130 parts by weight, 140 parts by weight, 150 parts by weight, 160 parts by weight, 170 parts by weight, 180 parts by weight, 190 parts by weight, or 200 parts by weight, or in a range between two of these values, but the present invention is not limited thereto.

The reinforcing material may also be treated with an additive that can improve dispersibility with the rubber, for example, an alkoxy silane. Therefore, since the additive may functionalize the hydrophobic rubber and hydrophobize the hydrophilic reinforcing material through surface treatment, thereby enhancing the dispersibility of the reinforcing material and inducing mutual bonding between the rubber and the reinforcing material, the physical properties of the final product can be improved.

The rubber composition may further include at least one additive selected from the group consisting of a processing aid, a vulcanizing agent, a vulcanization accelerator, a coupling agent, an antioxidant, a softener, and an adhesive.

The rubber composition may be used for a tire, and for example, may be used in tread rubber or sidewall rubber, but the present invention is not limited thereto.

The rubber composition may further include at least one selected from the group consisting of an aromatic petroleum resin, an aliphatic olefin polymer, and a farnesene-based polymer.

The aromatic petroleum resin, aliphatic olefin polymer, and farnesene-based polymer may supplement the role of a processing aid and improve the physical properties of the rubber composition.

Hereinafter, examples in the present specification will be described in further detail. However, the following experimental results are only representative experimental results among the above examples, and the scope and contents of present specification may not be interpreted as being reduced or limited by the examples. Each effect of the various embodiments of the present specification, which is not explicitly presented below, is specifically described in the corresponding section.

### PREPARATION EXAMPLE 1-1

Diethyliminodiacetate (8.0 g, 0.04 mol) of Formula A-1, methylene chloride (40 mL) and trimethylamine (2.3 g, 0.04 mol) were mixed in a 200 mL nitrogen-filled reactor and cooled to −10° C. After slowly adding trimethylchlorosilane (4.2 g, 0.04 mol), the mixture was warmed to room temperature and then stirred. After filtration, a solvent was removed under reduced pressure, the resulting product was washed with acetonitrile and heptane, and only the heptane layer was separated and concentrated, thereby obtaining 8.2 g (yield: 82%) of a compound.

The obtained compound was analyzed by nuclear magnetic resonance (NMR) to confirm that it had the structure of Formula A-2, and the result is as follows.

¹H NMR (400 MHz, CDCl₃) δ 0.12 (S, CH₃), δ 1.15 (t, CH₃), δ 3.34 (S, CH₂), δ 4.05 (q, CH₂)

¹³C NMR (100 MHz, CDCl₃) δ 1.96 (CH₃), δ 14.3 (CH₃), δ 50.2 (CH₂), δ 60.9 (CH₂), δ 171.8 (C)

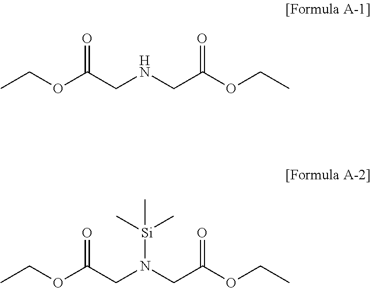

### PREPARATION EXAMPLE 1-2

Tetraethyl 2,2′-((2-methylpentane-1,5-diyl)bis(azanediyl)) disuccinate (19.0 g, 0.04 mol) of Formula B-1, methylene chloride (40 mL) and trimethylamine (4.6 g, 0.08 mol) were mixed in a 200 mL nitrogen-filled reactor and cooled to −10° C. After slowly adding trimethylchlorosilane (8.6 g, 0.08 mol), the resulting mixture was warmed to room temperature and stirred. After filtration, a solvent was removed under reduced pressure, the resulting product was washed with acetonitrile and heptane, and only the heptane layer was separated and concentrated, thereby obtaining 20 g (yield: 80%) of the compound of Formula B-2.

The obtained compound was analyzed by NMR to confirm that it had the structure of Formula B-2, and the result is shown below.

¹H NMR (400 MHZ, CDCl₃) δ 0.08 (S, CH₃), δ 0.7 (d, CH₃), δ 1.1 (q, CH₃), δ 1.2 to 1.4 (m, CH₂), δ 2.05 to 2.2 (m, CH₂), δ 2.2 to 2.4 (m, CH₂), δ 2.4 to 2.6 (m, CH₂), δ 3.4 (q, CH₂), δ 3.9 to 4.0 (m, CH₂)

¹³C NMR (100 MHz, CDCl₃) δ 1.63 (CH₃), δ 14.1 (CH₃), δ 17.8 (CH₃), δ 27.3 (CH₂), δ 27.4 (CH₂), δ 32.0 (CH₂), δ 32.1 (CH₂), δ 33.2 (CH₂), δ 33.3 (CH), δ 38.0 (CH₂), δ 38.1 (CH₂), δ 48.2 (CH₂), δ 54.1 (CH₂), δ 54.2 (CH₂), δ 57.7 (CH) δ 58.0 (CH), δ 58.1 (CH), δ 60.4 (CH₂), δ 60.5 (CH₂), δ 60.8 (CH₂), δ 61.1 (CH₂), δ 170.7 (C), δ 173.5 (C), δ 173.6 (C), δ 173.7 (C)

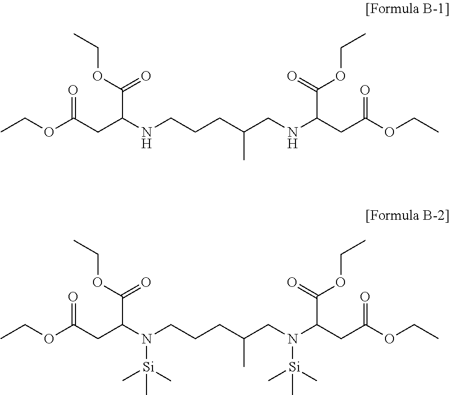

### PREPARATION EXAMPLE 1-3

The distearyl 3,3-thiodipropionate of Formula C-1 was purchased commercially and used.
(1) Ethyl thioglycolate (5.0 g, 0.04 mol), dimethylformamide (40 mL) and triethylamine (4.0 g, 0.04 mol) were mixed in a 200 mL nitrogen-filled reactor and cooled to −10° C. The resulting mixture was slowly warmed to room temperature and stirred. The reactant product was extracted with diethyl ether, and then an organic layer was separated and washed with water. Residual moisture was removed with sodium sulfate. After filtration, a solvent was removed under reduced pressure and the residue was concentrated, thereby obtaining 3.8 g (yield: 80%) of a compound. The obtained compound was analyzed by NMR to confirm that it had the structure of Formula C-2.
(2) A reflux condenser was connected to a 200 mL nitrogen-filled reactor. After adding ethyl thioglycolate (9.0 g, 0.05 mol), octyl alcohol (13.5 g, 0.10 mol), toluene (50 mL) and toluene sulfonic acid (0.2 g), the temperature of the reactor was raised while the mixture was stirred. Volatile components were separated using a Dean-Stark trap. The remaining organic-water layer was separated and washed with water. Residual water was removed with sodium sulfate. After filtration, a solvent was removed under reduced pressure and the residue was concentrated, thereby obtaining 18.1 g (yield: 90%) of a compound. The obtained compound was analyzed by NMR to confirm that it had the structure of Formula C-2.

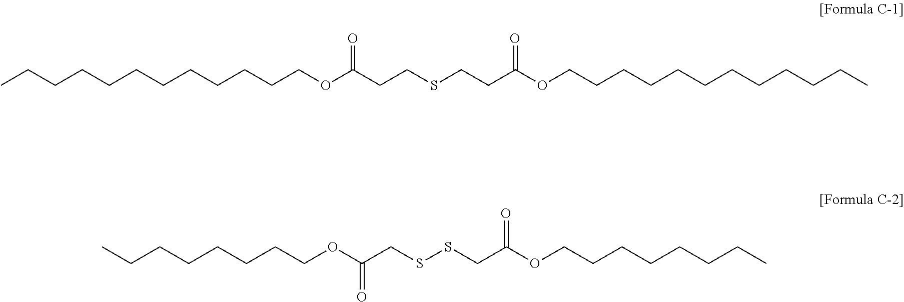

The NMR analysis results for the compound prepared by the method described in (1) and (2) are as follows.

¹H NMR (400 MHZ, CDCl₃) δ 1.0 (t, CH₃), δ 1.35 (m, CH₂), δ 1.7 (m, CH₂), δ 3.64 (s, CH₂), δ 4.2 (t, CH₂)

¹³C NMR (100 MHz, CDCl₃) δ 14 (CH₃), δ 22 (CH₂), δ 26 (CH₂), δ 28 (CH₂), δ 29 (CH₂), δ 29.3 (CH₂), δ 32 (CH₂), δ 41 (CH₂), δ 66 (CH₂), δ 169 (C)

### PREPARATION EXAMPLE 1-4

Methyl tin mercaptide of Formula D-1 and octyl tin mercaptide of Formula D-2 were purchased commercially and used.

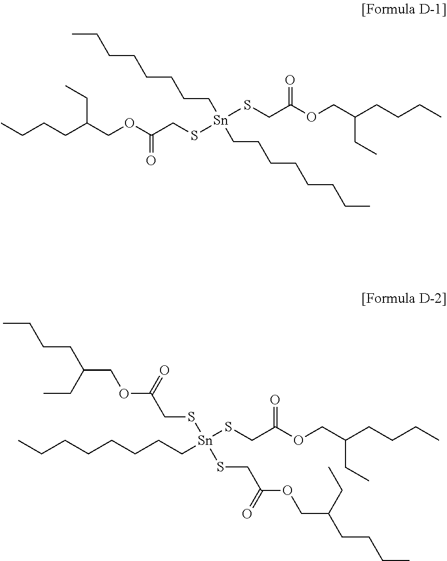

### COMPARATIVE EXAMPLE 1

After mixing 1,3-butadiene (15.6 mmol) in a unimolecular neodymium versatate (1.2 mmol) solution, diisobutylaluminum hydride (15.9 mmol), triisobutylaluminum (16.2 mmol) and diisobutylaluminum chloride (2.6 mmol) were added to prepare a catalyst. Here, the content of neodymium in the unimolecular neodymium versatate was 1.5×10⁻⁴ moles per 100 g of the single molecule.

A polymerization reaction was carried out by sufficiently blowing nitrogen into a 5 L high-pressure glass reactor and then adding a cyclohexane polymerization solvent in an amount five times the content of the monomer. After transferring and adding the catalyst under nitrogen charging, butadiene (400 g) as a monomer was added and polymerized at 70° C. for 2 hours. After polymerization, the reaction was terminated by adding a reaction terminator and an antioxidant, thereby obtaining high molecular weight 1,4-polybutadiene.

After mixing 1,3-butadiene (21.1 mmol) in a unimolecular neodymium versatate (1.62 mmol) solution, diisobutylaluminum hydride (70.1 mmol), triisobutylaluminum (21.5 mmol), and diisobutylaluminum chloride (3.5 mmol) were added, thereby preparing a catalyst. Here, the content of neodymium in the unimolecular neodymium versatate was 1.5×10⁻⁴ moles per 100 g of the single molecule.

The polymerization reaction was carried out by sufficiently blowing nitrogen into a 5 L high-pressure glass reactor and then adding a cyclohexane polymerization solvent in an amount six times the monomer content. After transferring and adding the catalyst under nitrogen charging, butadiene (400 g) as a monomer was added and polymerized at 70° C. for 2 hours. After polymerization, the reaction was terminated by adding a reaction terminator and an antioxidant, thereby obtaining low molecular weight 1,4-polybutadiene.

The high molecular weight 1,4-polybutadiene and the low molecular weight 1,4-polybutadiene were mixed for 1 hour or more at a weight ratio of 100:27, thereby preparing a 1,4-polybutadiene mixture.

### COMPARATIVE EXAMPLE 2

A 1,4-polybutadiene mixture was prepared in the same manner as Comparative Example 1, except that high molecular weight 1,4 polybutadiene and low molecular weight 1,4-polybutadiene were mixed at a weight ratio of 100:21.

### COMPARATIVE EXAMPLE 3

A 1,4-polybutadiene mixture was prepared in the same manner as Comparative Example 1, except that high molecular weight 1,4 polybutadiene and low molecular weight 1,4-polybutadiene were mixed at a weight ratio of 100:14.

### EXAMPLE 1

After mixing 1,3-butadiene (15.6 mmol) in a unimolecular neodymium versatate (1.2 mmol) solution, diisobutylaluminum hydride (15.9 mmol), triisobutylaluminum (16.2 mmol) and diisobutylaluminum chloride (2.6 mmol) were added to prepare a catalyst. Here, the content of neodymium in the unimolecular neodymium versatate was 1.5×10⁻⁴ moles per 100 g of the single molecule.

A polymerization reaction was carried out by sufficiently blowing nitrogen into a 5 L high-pressure glass reactor and then adding a cyclohexane polymerization solvent in an amount five times the content of the monomer. After transferring and adding the catalyst under nitrogen charging, butadiene (400 g) as a monomer was added and polymerized at 70° C. for 2 hours. After polymerization, the compound of Formula A-1 was slowly added and allowed to react for 50 minutes and the reaction was terminated by adding a reaction terminator and an antioxidant, thereby obtaining high molecular weight functionalized 1,4-polybutadiene.

After mixing 1,3-butadiene (21.1 mmol) in a unimolecular neodymium versatate (1.62 mmol) solution, diisobutylaluminum hydride (70.1 mmol), triisobutylaluminum (21.5 mmol) and diisobutylaluminum chloride (3.5 mmol) were added to prepare a catalyst. Here, the content of neodymium in the unimolecular neodymium versatate was 1.5×10⁻⁴ moles per 100 g of the single molecule.

A polymerization reaction was carried out by sufficiently blowing nitrogen into a 5 L high-pressure glass reactor and then adding a cyclohexane polymerization solvent in an amount six times the content of the monomer. After transferring and adding the catalyst under nitrogen charging, butadiene (400 g) as a monomer was added and polymerized at 70° C. for 2 hours. After polymerization, the compound of Formula A-1 was slowly added and allowed to react for 50 minutes and the reaction was terminated by adding a reaction terminator and an antioxidant, thereby obtaining low molecular weight functionalized 1,4-polybutadiene.

The high molecular weight functionalized 1,4-polybutadiene and the low molecular weight functionalized 1,4-polybutadiene were mixed for 1 hour or more at a weight ratio of 100:27, thereby preparing a functionalized 1,4-polybutadiene mixture.

### EXAMPLE 2

A functionalized 1,4-polybutadiene mixture was obtained in the same manner as in Example 1, except that the compound of Formula A-2 was added instead of the compound of Formula A-1.

### EXAMPLE 3

A functionalized 1,4-polybutadiene mixture was obtained in the same manner as in Example 1, except that the compound of Formula B-1 was added instead of the compound of Formula A-1.

### EXAMPLE 4

A functionalized 1,4-polybutadiene mixture was obtained in the same manner as in Example 1, except that the compound of Formula B-2 was added instead of the compound of Formula A-1.

### EXAMPLE 5

A functionalized 1,4-polybutadiene mixture was obtained in the same manner as in Example 1, except that the compound of Formula C-1 was added instead of the compound of Formula A-1.

### EXAMPLE 6

A functionalized 1,4-polybutadiene mixture was obtained in the same manner as in Example 1, except that the compound of Formula C-2 was added instead of the compound of Formula A-1.

### EXAMPLE 7

A functionalized 1,4-polybutadiene mixture was obtained in the same manner as in Example 1, except that the compound of Formula D-1 was added instead of the compound of Formula A-1.

### EXAMPLE 8

A functionalized 1,4-polybutadiene mixture was obtained in the same manner as in Example 1, except that the compound of Formula D-2 was added instead of the compound of Formula A-1.

### EXAMPLE 9

A functionalized 1,4-polybutadiene mixture was obtained in the same manner as in Example 1, except that the compound of Formula B-2 was added instead of the compound of Formula A-1, and high molecular weight functionalized 1,4-polybutadiene and low molecular weight functionalized 1,4-polybutadiene were mixed at a weight ratio of 100:21.

### EXAMPLE 10

A functionalized 1,4-polybutadiene mixture was obtained in the same manner as in Example 1, except that the compound of Formula C-1 was added instead of the compound of Formula A-1, and high molecular weight functionalized 1,4-polybutadiene and low molecular weight functionalized 1,4-polybutadiene were mixed at a weight ratio of 100:21.

### EXAMPLE 11

A functionalized 1,4-polybutadiene mixture was obtained in the same manner as in Example 1, except that the compound of Formula D-2 was added instead of the compound of Formula A-1, and high molecular weight functionalized 1,4-polybutadiene and low molecular weight functionalized 1,4-polybutadiene were mixed at a weight ratio of 100:21.

### EXAMPLE 12

A functionalized 1,4-polybutadiene mixture was obtained in the same manner as in Example 1, except that the compound of Formula A-2 was added instead of the compound of Formula A-1, and high molecular weight functionalized 1,4-polybutadiene and low molecular weight functionalized 1,4-polybutadiene were mixed at a weight ratio of 100:12.

### EXAMPLE 13

A functionalized 1,4-polybutadiene mixture was obtained in the same manner as in Example 1, except that the compound of Formula C-1 was added instead of the compound of Formula A-1, and high molecular weight functionalized 1,4-polybutadiene and low molecular weight functionalized 1,4-polybutadiene were mixed at a weight ratio of 100:12.

### EXAMPLE 14

A functionalized 1,4-polybutadiene mixture was obtained in the same manner as in Example 1, except that the compound of Formula D-1 was added instead of the compound of Formula A-1, and high molecular weight functionalized 1,4-polybutadiene and low molecular weight functionalized 1,4-polybutadiene were mixed at a weight ratio of 100:12.

Here, the low molecular weight 1,4-polybutadiene had a molecular weight of 5,000 to 100,000 g/mol, and the high molecular weight 1,4-polybutadiene had a molecular weight of 125,000 to 1,000,000 g/mol.

### EXPERIMENTAL EXAMPLE 1

The properties of the 1,4-polybutadienes prepared according to Comparative Examples 1 to 3 and Examples 1 to 14 were analyzed, and the results are shown in Table 1 below.

The analysis methods are as follows.

### 1) Measurement of Molecular Weight

A molecular weight was measured through gel permeation chromatography (GPC) using a tetrahydrofuran (THF) solvent, and a crosslinked polystyrene-divinylbenzene standard material.

### 2) Measurement of Solution Viscosity

After a solidified and dried sample was dissolved in toluene to have a concentration of 5.23 wt %, a viscosity at 25 ° C. (cps@25° C.) was measured using an automatic viscosity measuring device.

### 3) Measurement of Mooney Viscosity

30 g of solid rubber was taken, and two specimens with a thickness of 0.8 cm and an area of 5 cm×5 cm were produced using a roller. The specimens were attached to the front and back of the rotor, and then mounted on a rotation viscometer (ALPHA Technologies, MOONEY MV2000). The specimens were initially preheated to 100° C. for one minute, the rotor started to run, and the change in viscosity of the solid rubber over 4 minutes was measured to obtain a Mooney viscosity expressed as a value of ML1+4 (100° C.).

### 4) Measurement of Cold Flow

Measurement was performed by extruding rubber through a ¼-inch orifice under conditions of a pressure of 3.5 psi and a temperature of 50° C. Cold flow was confirmed by measuring an extrusion speed (mg/min) for 10 minutes after reaching a steady state.

### 5) Measurement of Cis Content

To confirm the microstructure of the solid rubber, the content of each structure was measured by the Morero method. 40 mg of the solid rubber sample was completely dissolved in 5 mL of CS₂, and the rubber solution was placed in KBr cells with 1 mm spacing, followed by performing measurement using an infrared spectrometer (FTS-60A, BIO-RAD). Here, infrared peaks to be measured are cis absorbance (AC) at 739 cm⁻¹, vinyl absorbance (AV) at 912 cm⁻¹, and trans absorbance (AT) at 966 cm⁻¹. The content of each microstructure was calculated from measured absorbance using the following equations.

$$C = ( 1.7 \; 455 \times AC - 0.0151 \times AV ) \qquad < Equ a t ions >$$

$$V = ( 0.37 \; 46 \times AV - 0.007 \times AC )$$

$$T = ( 0.42 \; 92 \times AT - 0.01 \; 29 \times AV - 0.0454 \times AC )$$

$$Cis ( \% ) = \frac{C}{C + V + T} \times 100$$

$$Trans ( \% ) = \frac{T}{C + V + T} \times 100$$

$$Vinyl ( \% ) = \frac{V}{C + V + T} \times 100$$

TABLE 1

| | | | | Solution | Mooney | | Cold | | | |
|---|---|---|---|---|---|---|---|---|---|---|
| | GPC (×10³ g/mol) | | | viscosity | viscosity | | flow | Cis | Trans | Vinyl |
| Classification | Mn | Mw | MWD | (cps) | (MV) | Linearity | (mg/min) | (%) | (%) | (%) |
| Comparative | 957 | 5,833 | 6.10 | 192 | 38 | 2.0 | 1.1 | 95.5 | 3.6 | 0.9 |
| Example 1 | | | | | | | | | | |
| Comparative | 998 | 6,145 | 6.16 | 235 | 42 | 1.8 | 0.8 | 95.7 | 3.4 | 0.9 |
| Example 2 | | | | | | | | | | |
| Comparative | 855 | 5,933 | 6.94 | 334 | 55 | 1.6 | 0.6 | 95.0 | 4.0 | 0.8 |
| Example 3 | | | | | | | | | | |
| Example 1 | 973 | 5,719 | 5.88 | 195 | 41 | 2.1 | 0.8 | 96.0 | 3.2 | 0.8 |
| Example 2 | 1,136 | 6,114 | 5.38 | 200 | 43 | 2.2 | 0.9 | 96.0 | 3.1 | 0.9 |
| Example 3 | 997 | 6,425 | 6.44 | 203 | 42 | 2.1 | 0.8 | 95.8 | 3.2 | 1.0 |
| Example 4 | 1,258 | 5,925 | 4.71 | 209 | 43 | 2.1 | 0.8 | 96.0 | 3.2 | 0.8 |
| Example 5 | 1,166 | 6,084 | 5.22 | 203 | 43 | 2.1 | 0.9 | 95.8 | 3.3 | 0.9 |
| Example 6 | 1,015 | 6,110 | 6.02 | 198 | 42 | 2.1 | 1.0 | 95.7 | 3.5 | 0.8 |
| Example 7 | 1,314 | 6,075 | 4.62 | 199 | 42 | 2.1 | 1.0 | 96.2 | 2.9 | 0.9 |
| Example 8 | 1,298 | 5,998 | 4.62 | 208 | 43 | 2.1 | 0.8 | 94.8 | 4.2 | 1.0 |
| Example 9 | 1,357 | 6,081 | 4.48 | 243 | 46 | 1.9 | 0.7 | 95.8 | 3.2 | 1.0 |
| Example 10 | 1,186 | 6,384 | 5.38 | 236 | 45 | 1.9 | 0.7 | 95.5 | 3.4 | 1.1 |
| Example 11 | 1,359 | 6,121 | 4.50 | 240 | 46 | 1.9 | 0.6 | 95.5 | 3.5 | 1.0 |
| Example 12 | 1,486 | 6,487 | 4.37 | 339 | 59 | 1.7 | 0.5 | 95.2 | 4.1 | 0.9 |
| Example 13 | 1,596 | 6,298 | 3.95 | 342 | 60 | 1.8 | 0.5 | 94.9 | 4.2 | 0.9 |
| Example 14 | 1,546 | 6,975 | 4.51 | 340 | 58 | 1.7 | 0.5 | 95.1 | 4.0 | 0.9 |

Referring to Table 1, compared to Comparative Examples I to 3 having no separate functional group, Examples 1 to 14 showed similar cis/trans/vinyl proportions and excellent solution viscosity and cold flow compared to Mooney viscosity.

### EXPERIMENTAL EXAMPLE 2

After primary compounding the 1,4-polybutadiene mixtures of Comparative Examples 1 to 3 and Examples 1 to 14 with solution polymerized styrene-butadiene rubber (SSBR), a process oil (TDAE oil), silica, carbon black, zinc oxide, stearic acid, an antioxidant, and a wax in a 500 cc Brabender at 120° C. under the conditions shown in Tables 2 to 4 below, the resulting compound was mixed with sulfur and a vulcanization accelerator to prepare a secondary compound. After kneading in a roll mill at 80° C., the resulting compound was processed into a flat sheet form using a 2-mm roll and then left for 24 hours. A 2-mm sheet specimen for measuring physical properties was manufactured by vulcanizing as long as the crosslinking time measured by RPA using a press at 160° C.

Compounds including the 1,4-polybutadiene mixtures of Comparative Examples 1 to 3 and Examples 1 to 14 were named Comparative Preparation Example 2 and Preparation Example 2, respectively. For example, a compound including the 1,4-polybutadiene mixture of Comparative Example 1 was named Comparative Preparation Example 2-1, and a compound including the 1,4-polybutadiene mixture of Example 1 was named Preparation Example 2-1.

TABLE 2

| | Comparative | |
|---|---|---|
| Classification | Preparation Example 2 | Preparation Example 2 |
| SSBR | 60 | 60 |
| Mixture of Comparative | 40 | 40 |
| Example/Example | | |
| TDAE oil | 50 | 50 |
| Silica | 90 | 90 |
| Carbon black | 10 | 10 |
| Zinc oxide | 3 | 3 |
| Stearic acid | 2 | 2 |
| Antioxidant | 1.5 | 1.5 |
| Wax | 2 | 2 |
| Sulfur | 1.6 | 1.6 |
| Vulcanization accelerator | 2 | 2 |

(Units: parts by weight)

The mechanical and dynamic properties of the specimens were measured and compared, and the results are shown in Tables 3 to 6 below. A method of measuring each physical property is as follows.
Hardness: measured using a SHORE-A hardness scale.
Moduli at 100% and 300% elongation: Stress acting on a specimen when the specimen was elongated 100% and 300% at 25° C. was measured (Units: kgf/cm²).
Tensile strength: measured in accordance with ASTM D 790 (Units: kgf/cm²)
Elongation rate: A strain value until the specimen breaks was measured using a tensile tester (Units: %).
Dynamic property values of vulcanized rubber (tan δ, E″, E′, E*): Values at 0° C. and 60° C. were analyzed using a DTMA 5 device (Rheometic).
Lambourn abrasion: The amount lost due to abrasion was analyzed after testing under the conditions of 30% slip, 40N, and 80 m/s using a Lambourn abrasion tester (Units: g).
DIN abrasion: The amount lost by crumbling was measured through mechanical repetitive movement on the surface of a specimen (Units: g)

TABLE 3

| | Comparative | | | | |
|---|---|---|---|---|---|
| | Preparation | Preparation | Preparation | Preparation | Preparation |
| Classification | Example 2-1 | Example 2-1 | Example 2-2 | Example 2-3 | Example 2-4 |
| Compound | 89 | 87 | 88 | 86 | 87 |
| Mooney | | | | | |
| viscosity | | | | | |
| Hardness | 69 | 69 | 70 | 70 | 70 |
| (Shore A) | | | | | |
| Modulus at | 27.5 | 27.6 | 28.1 | 26.9 | 28.4 |
| 100% | | | | | |
| elongation | | | | | |
| Modulus at | 95.7 | 98 | 97.8 | 96.9 | 97.2 |
| 300% | | | | | |
| elongation | | | | | |
| Tensile strength | 198.2 | 200.5 | 208.4 | 206.9 | 197.6 |
| Elongation rate | 537.5 | 520.9 | 532.9 | 536.1 | 541.5 |
| tanδ@0° C. | 0.268 | 0.264 | 0.267 | 0.281 | 0.273 |
| tanδ@60° C. | 0.142 | 0.133 | 0.138 | 0.143 | 0.131 |
| Lambourn | 0.049 | 0.049 | 0.050 | 0.045 | 0.047 |
| abrasion (g) | | | | | |
| DIN abrasion | 0.127 | 0.12 | 0.125 | 0.128 | 0.127 |
| (g) | | | | | |

TABLE 4

| | Comparative | | | | |
|---|---|---|---|---|---|
| | Preparation | Preparation | Preparation | Preparation | Preparation |
| Classification | Example 2-1 | Example 2-5 | Example 2-6 | Example 2-7 | Example 2-8 |
| Compound | 89 | 85 | 86 | 85 | 86 |
| Mooney | | | | | |
| viscosity | | | | | |
| Hardness | 69 | 70 | 70 | 69 | 70 |
| (Shore A) | | | | | |
| Modulus at | 27.5 | 27.9 | 28.3 | 27.9 | 27.3 |
| 100% | | | | | |
| elongation | | | | | |
| Modulus at | 95.7 | 96.9 | 95.2 | 95.9 | 98.3 |
| 300% | | | | | |
| elongation | | | | | |
| Tensile strength | 198.2 | 208.5 | 210.1 | 209.4 | 208.6 |
| Elongation rate | 537.5 | 539.2 | 540.8 | 539.8 | 557.4 |
| tanδ@0° C. | 0.268 | 0.262 | 0.279 | 0.267 | 0.284 |
| tanδ@60° C. | 0.142 | 0.14 | 0.138 | 0.135 | 0.133 |
| Lambourn | 0.049 | 0.048 | 0.047 | 0.046 | 0.048 |
| abrasion (g) | | | | | |
| DIN abrasion | 0.127 | 0.126 | 0.126 | 0.124 | 0.125 |
| (g) | | | | | |

TABLE 5

| | Comparative | | | |
|---|---|---|---|---|
| | Preparation | Preparation | Preparation | Preparation |
| Classification | Example 2-2 | Example 2-9 | Example 2-10 | Example 2-11 |
| Compound | 95 | 93 | 93 | 92 |
| Mooney viscosity | | | | |
| Hardness (Shore A) | 70 | 70 | 70 | 70 |
| Modulus at 100% | 28.8 | 28.8 | 29 | 30.3 |
| elongation | | | | |
| Modulus at 100% | 99.3 | 104 | 103.3 | 102.8 |
| elongation | | | | |
| Tensile strength | 214.3 | 215.9 | 217.1 | 216.4 |
| Elongation rate | 555.3 | 566.1 | 549.5 | 568.3 |
| tanδ@0° C. | 0.259 | 0.256 | 0.257 | 0.264 |
| tanδ@60° C. | 0.135 | 0.128 | 0.129 | 0.131 |
| Lambourn abrasion | 0.047 | 0.047 | 0.045 | 0.046 |
| (g) | | | | |
| DIN abrasion (g) | 0.114 | 0.115 | 0.110 | 0.113 |

TABLE 6

| | Comparative | | | |
|---|---|---|---|---|
| | Preparation | Preparation | Preparation | Preparation |
| Classification | Example 2-3 | Example 2-12 | Example 2-13 | Example 2-14 |
| Compound | 101 | 98 | 99 | 97 |
| Mooney viscosity | | | | |
| Hardness (Shore A) | 71 | 71 | 71 | 71 |
| Modulus at 100% | 30 | 30.1 | 29.8 | 29.7 |
| elongation | | | | |
| Modulus at 100% | 103.7 | 102.1 | 100.5 | 104.8 |
| elongation | | | | |
| Tensile strength | 222.8 | 221.5 | 231.5 | 219.4 |
| Elongation rate | 572.5 | 536.8 | 589.1 | 578.8 |
| tanδ@0° C. | 0.242 | 0.251 | 0.239 | 0.244 |
| tanδ@60° C. | 0.129 | 0.128 | 0.119 | 0.123 |
| Lambourn abrasion | 0.042 | 0.040 | 0.039 | 0.042 |
| (g) | | | | |
| DIN abrasion (g) | 0.108 | 0.112 | 0.113 | 0.107 |

Referring to Tables 3 to 6, compared to Comparative Preparation Example 2 using the 1,4-polybutadiene mixture of Comparative Examples, Preparation Example 2 using the functionalized 1,4-polybutadiene mixture of Examples exhibited excellent processability due to a reduced compound Mooney viscosity. In addition, physical properties and dynamic properties expressed as tan δ@60° C. were improved by the action of a functional group.

According to one aspect, polyfunctionalized high-cis rubber having excellent physical properties and excellent processability can be provided.

The effects of one aspect in the specification are not limited to the above effect, and should be understood to include all effects that can be inferred from the configuration described in the detailed description or claims of the specification.

It should be understood by those of ordinary skill in the art that the above description of the present specification is exemplary, and the exemplary embodiments disclosed herein can be easily modified into other specific forms without departing from the technical spirit or essential features of the present specification. Therefore, the exemplary embodiments described above should be understood as illustrative in all aspects and not restrictive. For example, each component described as a single unit may be implemented in a distributed manner, and components described as being distributed may also be implemented in a combined form.

The scope of the present invention is defined by the appended claims and encompasses all modifications and alterations derived from meanings, the scope and equivalents of the appended claims.

What is claimed is:

1. A rubber mixture, comprising:
a first high molecular weight rubber polymer, which includes a unit structure derived from a first conjugated diene-based monomer and is functionalized with at least one of the compounds represented by Formulas 1 to 6 below; and
a second low molecular weight rubber polymer, which includes a unit structure derived from a second conjugated diene-based monomer and is functionalized with at least one of the compounds represented by Formulas 1 to 6 below,
[Formula 1]
▮ [symbol]
[Formula 2]
▮ [symbol]
[Formula 3]
▮ [symbol]
[Formula 4]
▮ [symbol]
[Formula 5]
▮ [symbol]
[Formula 6]
▮ [symbol]
In the above formulas,
A′ is nitrogen or phosphorus,
B′ is oxygen or sulfur,
C′ is silicon or tin,
Y is hydrogen, —R₂, —Si(R₂)₃, or —R₁Si(OR₂)₃,
Z is a functional group represented by Formula Z below,
n is an integer of 1 to 3,
m is an integer of 1 or more,
k is 1 or 2,
l is an integer of 1 to 4, and
o is 0 or 1,
[Formula Z]
▮ [symbol]
R₁ is each independently a linear or branched, substituted or unsubstituted C1-C10 alkylene group, and
R₂ is each independently a linear or branched, substituted or unsubstituted C1-C20 alkyl group, substituted or unsubstituted C3-C20 cycloalkyl group, or substituted or unsubstituted C6-C20 aryl group.

2. The rubber mixture of claim 1, wherein each of the first conjugated diene-based monomer and the second conjugated diene-based monomer is at least one selected from the group consisting of 1,3-butadiene, isoprene, 2,3-dimethyl-1,3-butadiene, 2,3-dimethylbutadiene, 2-phenyl-1,3-butadiene, 2-chloro-1,3-butadiene, 1,3-pentadiene, 2-methyl-1,3-pentadiene, 3-methyl-1,3-pentadiene, 4-methyl-1,3-pentadiene, 1,3-hexadiene, 2-ethyl-1,3-butadiene, 2,4-hexadiene, and 1,3-cyclohexadiene.

3. The rubber mixture of claim 1, wherein the first rubber polymer has a weight average molecular weight of 100,000 to 1,500,000 g/mol.

4. The rubber mixture of claim 1, wherein the second rubber polymer has a weight average molecular weight of 5,000 to 100,000 g/mol.

5. The rubber mixture of claim 1, wherein the weight ratio of the first and second rubber polymers is 100:5 to 45.

6. The rubber mixture of claim 1, wherein the first and second rubber polymers are functionalized with the same compound.

7. The rubber mixture of claim 1, which has a molecular weight distribution of 3.5 or more.

8. The rubber mixture of claim 1, which has a linearity of 1.5 to 2.5.

9. The rubber mixture of claim 1, which has a cis content of 90 wt % or more.

10. A method of preparing a rubber mixture, comprising:
(a1) preparing a first high molecular weight rubber polymer by allowing a solution containing a first conjugated diene-based monomer, a first solvent, and a first catalyst to react, and further adding and allowing at least one of the compounds represented by Formulas 1 to 6 to react;
(a2) preparing a second low molecular weight rubber polymer by allowing a solution containing a second conjugated diene-based monomer, a second solvent, and a second catalyst to react, and further adding and allowing at least one of the compounds represented by Formulas 1 to 6 to react; and
(b) mixing the first high molecular weight rubber polymer and the second low molecular weight rubber polymer:
[Formula 1]
▮ [symbol]
[Formula 2]
▮ [symbol]
[Formula 3]
▮ [symbol]
[Formula 4]
▮ [symbol]
[Formula 5]
▮ [symbol]
[Formula 6]
▮ [symbol]
In the formulas,
A′ is nitrogen or phosphorus,
B′ is oxygen or sulfur,
C′ is silicon or tin,
Y is hydrogen, —R₂, —Si(R₂)₃, or —R₁Si(OR₂)₃,
Z is a functional group represented by Formula Z below,
n is an integer of 1 to 3,
m is an integer of 1 or more,
k is 1 or 2,
l is an integer of 1 to 4,
o is 0 or 1,
[Formula Z]
▮ [symbol]
R₁ is each independently a linear or branched, substituted or unsubstituted C1-C10 alkylene group, and
R₂ is each independently a linear or branched, substituted or unsubstituted C1-C20 alkyl group, substituted or unsubstituted C3-C20 cycloalkyl group, or substituted or unsubstituted C6-C20 aryl group.

11. The method of claim 10, wherein, in (a1), the weight ratio of the first conjugated diene-based monomer and the first solvent is 1:1 to 5.5, and
in (a2), the weight ratio of the second conjugated diene-based monomer and the second solvent is 1:5.5 to 1.

12. A rubber composition, comprising:
the rubber mixture according to claim 1;
at least one third rubber selected from the group consisting of natural rubber, polybutadiene rubber, polyisoprene rubber, butyl rubber, an ethylene-propylene-diene terpolymer, emulsion polymerized styrene-butadiene rubber, and solution polymerized styrene-butadiene rubber; and
a reinforcing material.

13. The rubber composition of claim 12, wherein the reinforcing material includes at least one selected from the group consisting of silica, carbon black, carbon nanotubes, calcium carbonate, clay, aluminum hydroxide, lignin, silicate, talc, syndiotactic-1,2-polybutadiene, titanium oxide, mica, vermiculite, and hydrotalcite.

14. The rubber composition of claim 12, wherein the rubber composition further includes at least one selected from the group consisting of an aromatic petroleum resin, an aliphatic olefin polymer, and a farnesene-based polymer.
